(19) United States
(12) Patent Application Publication
(10) Pub. No.: US 2024/0362034 A1
(43) Pub. Date: Oct. 31, 2024

(54) INTENT BASED SERVICE SCALING

(71) Applicant: Tata Communications Limited, Fort, Mumbai (IN)

(72) Inventor: Tushar SOOD, Kannamangala (IN)

(21) Appl. No.: 18/291,168

(22) PCT Filed: Jul. 29, 2022
(86) PCT No.: PCT/IB2022/057075

§ 371 Date: Jan. 22, 2024

(30) Foreign Application Priority Data
Jul. 29, 2021 (IN) 202121034147

(51) Int. Cl. G06F 9/448; G06F 9/50

(52) U.S. Cl. CPC G06F 9/448; G06F 9/505

(57) ABSTRACT

A method and system for scaling services at a Platform as a Service (PaaS) layer of a server, includes, at the PaaS layer of the server, executing an application as an application proxy; exposing the application proxy to a network; receiving a service request from a user of the network who accessed the application proxy; detecting an intent of the user; predicting services that are appropriate in response to the service request of the user based on the detected intent of the user; scaling the predicted services; and scheduling the application and any other supporting applications corresponding to the scaled predicted services for execution.

### FIELD

The present disclosure relates to cloud computing, and more particularly to intent-based service scaling methods and apparatus for edge computing services.

### BACKGROUND

Cloud-based computing includes servers, networks, storage, development tools, and applications, which are enabled through the internet. Cloud-computing eliminates the need for organizations to make huge investments in equipment, staff, and continuous maintenance, as some or all of these needs can be handled by a cloud service provider. Platform as a Service (PaaS) is one of a plurality of cloud-based edge computing service layers that enables businesses to create unique applications without making significant financial investments.

Cloud-based edge computing services at the PaaS layer, however, cannot adapt according to need of the user. Understanding the needs of the user is left to the application running on the PaaS layer of a cloud provider's edger server, which may not be in real time and can be rather slow as it involves context switching from application to application or platform to application.

Current methods for identifying intent for services at the PaaS layer, rely on static service scaling, which is based on some threshold on numeric parameters or on a poor service instantiation. Such methods do not operate in real time and work mechanically without understanding the true needs of the user.

Another problem with current service solutions at the PaaS layer, is that one service instance is always scaled out, which results in a constant cost to the user of the cloud service. FIG. 1A is a flowchart of a current (prior art) method for providing a virtual service at the PaaS layer of an edge server of a cloud service provider. In box 10, an application for a virtual service is registered to a load balancer running on a PaaS layer of the edge server of the cloud service provider. In the example shown in FIG. 1A, the application is a road map application for an automobile.

The PaaS load balancer is typically incorporated into an application delivery controller of the edge server. The application delivery controller can be a virtualized instance running on master nodes of edge clusters as control plane component running on the PaaS Layer. In box 12, the road map application is pulled from an external application repository or external storage and the load balancer exposes a Universal Resource Identifier (URI) of the map application to a Global Domain Name System (DNS). Applications are the services that are executed on the edge cluster. For an application to be accessible over internet it has to be linked to a globally visible IP address. This is implemented with a DNS record, which comprises the IP address and the DNS URL of the application. This IP address is determined by global DNS servers onto the associated IP. In box 12 available DNS services like CoreDNS, BIND DNS, Knot DNS, PowerDNS, etc., can perform this task.

In box 14, the URI of the map application is propagated globally. Global propagation is a well-known DNS process where DNS records are shared across globally DNS registrars. This is required so that the application of the virtual service can be reachable from across internet or any other network or mechanism from where cloud data centers or edge servers can be reached.

Consequently, in the prior art method of FIG. 1A, a single instance of the application (e.g., road map application) is always executed, thus, the owner of the map application is always charged for computing and storage usage of this virtual service, therefore, there is a constant application execution cost.

FIG. 1B is a block diagram depicting a single instance of an application 30 of a virtual service always executed at the PaaS layer 22 of an edge server 20 of a cloud provider according to the prior art method of FIG. 1A. The edge server 20 further includes a platform abstraction layer 24 underlying the PaaS layer 22, a hardware abstraction layer 26 underlying the platform abstraction layer 24 and a hardware layer 28 underlying the hardware abstraction layer 26. As shown, the edge server 20 includes the single instance of the application 30 (e.g., road map application), which is always executed at the PaaS layer 22, by a load balancer 32 running on the PaaS layer 22 of the edge server 20.

As depicted in FIG. 1C, because the road map application 30 is always executed under current methods, it can be accessed over the internet or other network. Therefore, when the load balancer 32 running on the PaaS layer 22 of the edge server 20 (FIG. 1B) of a cloud service provider 40, receives a service request for a road map from a user 42 of an automobile who accesses the URL of the road map application 30 (FIG. 1B), via a computing device of the automobile or other computing device, the load balancer 32 will route the request to the road map application 30 that is always executed, which in turn, delivers the requested road map to the user 30.

As illustrated in FIG. 1D, if the road map application 30 for the virtual service is not registered to the load balancer 32 running on the edge server 20 (FIG. 1B) of the cloud service provider 40, the road map application 30 will not be pulled, although the map application 30 is always running at the PaaS layer 22 of the edge server 20. Therefore, the user 42 of the automobile will receive a return error and no virtual service will be provided.

### SUMMARY

Disclosed herein is a method and apparatus where user intent is identified at the platform as a service (PaaS) layer of an edge server of a cloud computing service provider and in response, one or more applications that are appropriate for satisfying a user's virtual service request are executed. The method and apparatus derives an intent from incoming data contained in the user's virtual service request, and a load balancer of a delivery controller running on a PaaS layer of the edge server executes the one or more applications appropriate for the user's requested virtual service, based on the user's intent derived from the incoming data.

In various embodiments, the user intent contained in the incoming data is processed with an intent engine running in the PaaS layer of the edge server where one or more service URLs of the one or more appropriate applications for the requested virtual service are exposed to a network, such as the internet or any other network or mechanism from where cloud data centers or edge servers can be reached, without actually executing the applications. Further when a request to the one or more URLs of the one or more appropriate applications is made, the PaaS layer of the edge server scales the quantity of the one or more applications out or in, depending upon the determined intent of the user, executes the scaled one or more appropriate applications, and provides them to the user in response to the request for the virtual service.

The intent-based scaling method of the present disclosure commences with no managed services or container VM (virtual machine) instances. The bucket of applications/services is scaled based on the identified intent of the user. Instance scaling is predicted by unsupervised learning techniques, by defining intent. Scaling is proactive by understanding the user's intent. The intent-based scaling method of the present disclosure significantly reduces user cost at virtually no additional cost to the user. Applications corresponding to the requested virtual service are terminated and scaled in, therefore, saving physical resources to be used by others.

In various other embodiments, user intent can also be recognized by telematic numbers and then based on the intent, one or more appropriate applications are executed.

In various embodiments, an application is onboarded with category metadata such as, but not limited to News app, Media app, Gaming app, Emergency app, etc. The application is represented as an application proxy by the PaaS layer of the edge server of the cloud provider, making it always available. Once a virtual service request is made, appropriate applications or services that support the application are executed based on identified intent, therefore, a whole bucket of services are predicted and is scaled on platform. Once the request is replied to, services are scaled in or terminated as there is no more use, which saves substantial quantities of resources on the edge server as well as cost to platform users.

In various embodiments, a method for scaling services at a Platform as a Service (PaaS) layer of a server, comprises at the PaaS layer of the server: executing an application as an application proxy; exposing the application proxy to a network; receiving a service request from a user of the network who accessed the application proxy; detecting an intent of the user; predicting services that are appropriate in response to the service request of the user based on the detected intent of the user; scaling the predicted services; and scheduling the application and any other supporting applications corresponding to the scaled predicted services for execution.

In some embodiments of the method, the executing of the application as the application proxy and the exposing of the application proxy to the network is performed by an orchestrator running on the PaaS layer of the server.

In some embodiments of the method, the application proxy executes on a fraction of a virtual computer processing unit.

Some embodiments of the method further comprise registering the application to a load balancer using a YAML file prior to executing the application as the application proxy.

In some embodiments of the method, the PaaS layer includes the load balancer.

In some embodiments of the method, the load balancer receives the service request from the user.

In some embodiments of the method, the PaaS layer includes an intent engine for detecting the intent of the user and predicting of the services that are appropriate in response to the service request of the user based on the intent of the user.

In some embodiments of the method, the PaaS layer further includes an orchestrator and wherein the intent engine is a component of the orchestrator.

In some embodiments of the method, the PaaS layer includes a load balancer that executes the intent engine.

In some embodiments of the method, the intent engine comprises a neural network for detecting the intent of the user and predicting of the services that are appropriate in response to the service request of the user based on the intent of the user.

In some embodiments of the method, the neural network includes an input layer, neural network layers, and an output layer, wherein the input layer receives input parameters contained in the service request, wherein the neural network layers filter the input parameters to create a feature map that summarizes the presence of detected intent features in the input, and wherein the detected intent features are presented at the output layer as predicted services.

In some embodiments of the method, the PaaS layer includes a delivery controller for scheduling the executing of the application and any other supporting applications corresponding to the scaled predicted services is scheduled on an associated second server or on an associated computing device.

In some embodiments of the method, the server comprises an edge server of a cloud service provider.

In various embodiments, a system for scaling services based on identified intent, comprises: a server including a processor and a memory accessible by the processor; a set of processor readable instructions stored in the memory that are executable by the processor of the server to, at a PaaS layer of the server, execute an application as an application proxy; expose the application proxy to a network; receive a service request from a user of the network who accessed the application proxy; detect an intent of the user; predict services that are appropriate in response to the service request of the user based on the detected intent of the user; scale the predicted services; and schedule the application and any other supporting applications corresponding to the scaled predicted services for execution.

### BRIEF DESCRIPTION OF THE DRAWING

The disclosure is best understood from the following detailed description when read in conjunction with the accompanying drawing. It is emphasized that, according to common practice, the various features of the drawing are not necessarily to scale. On the contrary, the dimensions of the various features may be arbitrarily expanded or reduced for clarity. Like numerals denote like features throughout the specification and the drawing.

FIG. 1A is a flowchart of a prior art method for providing a virtual service at a PaaS layer of an edge server of a cloud service provider.

FIG. 1B is a block diagram depicting a single instance of an application of a virtual service always executed at the PaaS layer of an edge server of a cloud provider according to the prior art method of FIG. 1A.

FIG. 1C schematically depicts a road map application is always executed under the prior art method of FIG. 1A.

FIG. 1D schematically depicts what happens when the road map application is not registered to a load balancer running on the edge server of FIG. 1B.

FIG. 2 depicts a flowchart of a method, according to an exemplary embodiment of the present disclosure, for identifying intent in order to provide a virtual service at a PaaS layer of the edge server.

FIGS. 3A-3D are block diagrams of an exemplary edge server/master node and corresponding worker node (FIG. 3D) as it/they execute the method of FIG. 2.

FIG. 4 schematically depicts an exemplary embodiment of a neural network of an intent engine used in the method of FIG. 2.

FIG. 5 schematically depicts exemplary embodiments of virtual services scaled out according to the method of FIG. 2.

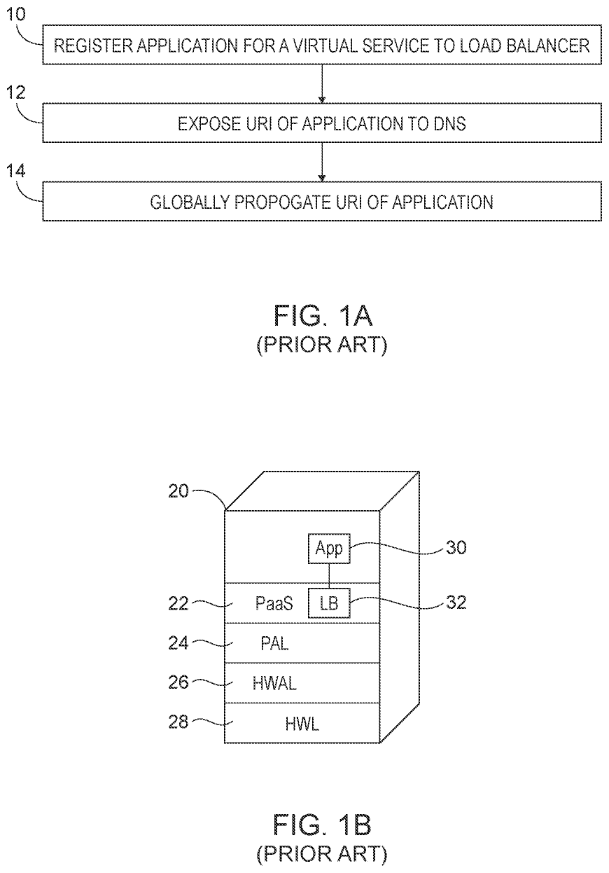

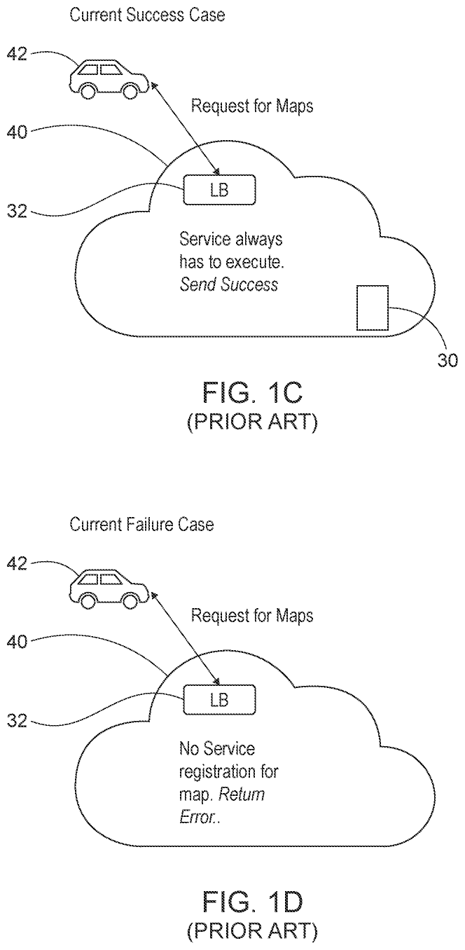

### DETAILED DESCRIPTION

It should be understood that the phraseology and terminology used below for the purpose of description and should not be regarded as limiting. The use herein of the terms “comprising,” “including,” “having,” “containing,” and variations thereof are meant to encompass the structures and features recited thereafter and equivalents thereof as well as additional structures and features. Unless specified or limited otherwise, the terms “attached,” “mounted,” “affixed,” “connected,” “supported,” “coupled,” and variations thereof are used broadly and encompass both direct and indirect forms of the same.

The methods described herein can be implemented in software (including firmware, resident software, micro-code, etc.). Furthermore, the present embodiments may take the form of a computer program product embodied in any tangible medium of expression having computer-usable program code embodied in the medium.

For the sake of clarity, only the operations and elements that are useful for an understanding of the embodiments described herein have been illustrated and described in detail. In particular, the electronic data processing/computing devices (e.g., servers) that can be used to implement the disclosed methods have not been described in detail, the disclosed embodiments being compatible with all or most of the known electronic data processing devices, or the production and/or programming of such devices being within the capabilities of one skilled in the art from the functional information provided in the present disclosure.

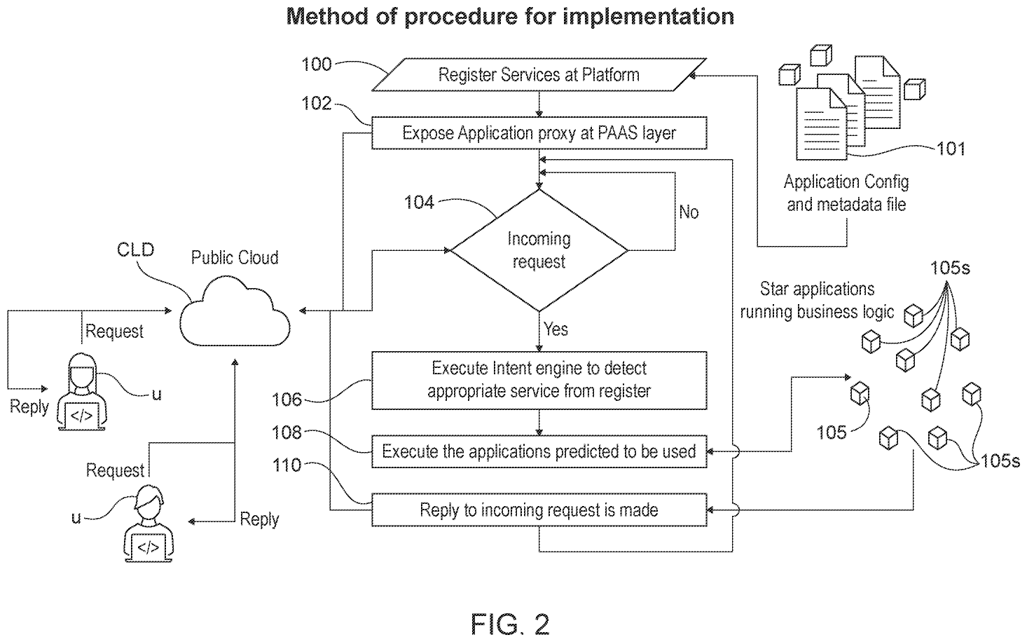

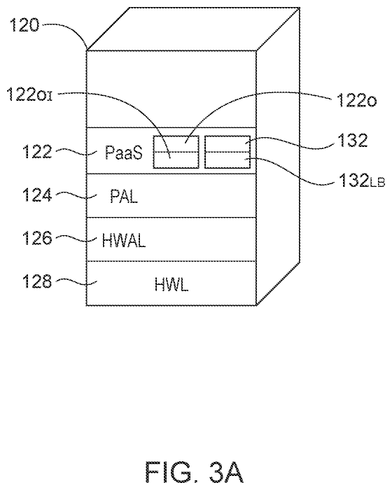

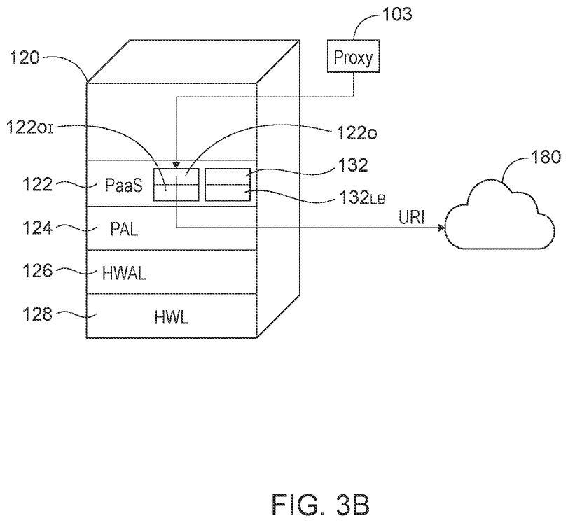

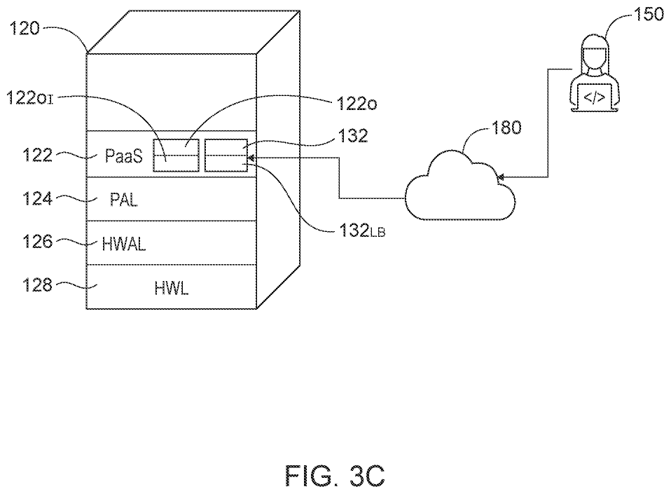

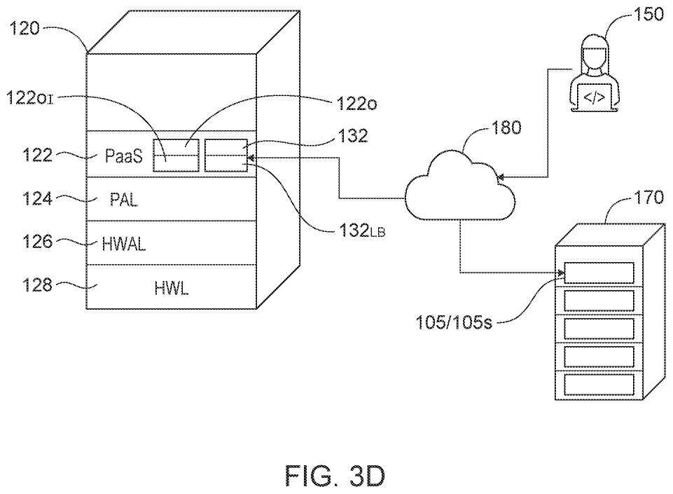

FIG. 2 depicts a flowchart of a method, according to an exemplary embodiment of the present disclosure, for identifying intent at the Platform-As-A-Service (PaaS) layer of an edge server of a cloud service provider CLD, in order to provide a virtual service at a PaaS layer of the edge server. The method of FIG. 2 will be described in conjunction with an exemplary embodiment of an edge server 120 which can comprise a single node of an edge cluster, as depicted in the block diagrams of FIGS. 3A-3D. The edge server 120 can be implemented as rack server, a Raspberry Pi device, or any suitable computing device and is operative as a master node of the edge cluster. The edge server/master node 120 includes a PaaS layer 122, a platform abstraction layer 124 underlying the PaaS layer 122, a hardware abstraction layer 126 underlying the platform abstraction layer 124 and hardware layer 128 underlying the hardware abstraction layer 126. The PaaS layer 122 has/runs an orchestrator 122_{O} that includes an analytical intent detection engine 122_{OI} that has intent-based scaling logic in the form of a neural network. The PaaS layer 122 also has/runs a delivery controller 132 that includes a load balancer 132_{LB}

[symbol]

In box 100 of FIG. 2, an application for a virtual service is registered to and stored in a local service register as an intent service, to the load balancer 132_{LB} of the delivery controller 132 running on the PaaS layer 122 of the edge server/master node 120 of FIG. 3A. The load balancer 132_{LB} distributes incoming application traffic across multiple targets, as will be explained further on. A YAML file 101 (FIG. 2) for describing the application is used when registering the application as an intent service to the load balancer 132_{LB}. The YAML file 101 is an application configuration and metadata file that essentially describes information about the application and how it should be executed, and is used by the PaaS layer to start the application and to start/execute an application proxy of the application and application proxies of supporting service(s)/application(s). An application proxy is a dummy application that is executed in the edge server/master node 120 to mimic the actual application. An application proxy does not contain any code or business logic. Instead, it is a program that executes on ˜0.001 milli CPU cycle (stated as a fraction of a vCPU, i.e., a fraction of a virtual processor which is a physical central processing unit that is assigned to a virtual machine). Since application proxies consume negligible resources, they are referred to as micro resources. Because application proxies consume a fraction of vCPU and memory, they incur much lower costs for the cloud provider than executed applications.

The YAML file 101 (FIG. 2) includes a field that provides the name of the application, a field that provides the application's repository image, a field that provides a port number the application runs on, and a labels field for dynamic parameters that can be added and/or updated based on use case. The YAML file is read and used by the PaaS layer 122 (FIG. 3A) to start the application when intent is recognized by the PaaS layer 122.

In box 102 of FIG. 2, the application and any supporting service(s) application(s) is/are executed as an application proxy/proxies 140 by the orchestrator 122_{O} of the PaaS layer 122 of the edge server/master node 120 (FIG. 3B), thus, consuming a miniscule quantity of resources in the hardware layer 128 of the edge server/master node 120 (FIG. 3B), while still making the application(s) always available. The application proxy/proxies 140 is/are exposed to internet 180 or any other network or mechanism from where cloud data centers or edge servers can be reached (FIG. 3B) over the same URI as the actual application(s). This can be performed with a map application executed by the orchestrator 122_{O} of the PaaS layer 122 so that when the load balancer 132_{LB} sends a user's service request to the application proxy, the map application will redirect the service request to actual application after it comes up.

If in box 104 of FIG. 2, no service request is received by the load balancer 132_{LB} running on the PaaS layer 122 of the edge server/master node (FIG. 3B) in response is to the exposure of the application proxy/proxies to the internet 180 or other network, the load balancer 132_{LB} continues to be available and waits for an incoming request. Meanwhile, the actual application and any possible service(s)/applications(s) which may be required to support the application, are not started.

In box 104 of FIG. 2, the load balancer 132_{LB} running on the PaaS layer 122 of the edge server/master node 120 (FIG. 3C) receives a service request from a user 150 who accesses the URL of the application proxy 103, via a computing device. In response, the load balancer 132_{LB}, in box 106 of FIG. 2, transmits the service request to the virtual service and executes the analytical intent detection engine (intent engine) 122_{OI} of the orchestrator 122_{OI} running on the PaaS layer 122. The virtual service forwards the service request to the corresponding proxy application. The intent engine 122_{OI} of the orchestrator 122_{O} running on the PaaS layer 122 monitors this event, and in response updates the virtual service which in turn, forwards the service request to the actual application. In addition, the intent engine 122_{OI} detects, identifies and classifies the user's intent, and predicts the application and any supporting service(s)/application(s) from one or more input parameters contained in the service request. The application and any supporting service(s)/application(s) predicted by the intent engine 122_{OI} are used by the PaaS layer 122 to scale the relevant application and any relevant supporting service(s)/application(s) stored in the local service register that are appropriate in response to the user's service request. The predicted application and supporting service(s)/application(s) can be scaled by the PaaS layer 122, as described further on, depending upon the user's intent. Scaling allows the quantity of applications executing on the edge server/master node 120 to be varied. If services are “scaled out” it, this indicates that applications are executed. If services are “scaled in” this indicates that applications are terminated. The load balancer 132_{LB} also balances the traffic among instances of services/applications being executed by the intent engine 122_{OI} of the orchestrator 122O running in the PaaS layer 122.

In box 108 of FIG. 2, the PaaS layer 122 of the edge server/master node 120 (FIG. 3D) executes the application 105 and any supporting service(s)/applications 105_{S} corresponding to the predicted application and scaled supporting service(s)/applications. More specifically, the delivery controller 132 running on the PaaS layer 122 of the edge server/master node 120 schedules the actual application(s) 105, 105_{S} on registered worker nodes/servers/computers 170 of corresponding edge clusters, which worker nodes/servers/computers 170 execute the application(s) 105, 105_{S} (FIG. 3D). Once the application and any supporting service(s)/application(s) 105, 105_{S} are executed successfully, the corresponding proxy application(s) 103 are scaled in (terminated) by the intent engine 122_{OI}. In box 110 of FIG. 2, the PaaS layer of the edge server/master node 120 replies to the user's incoming request with access to the executed application. In some embodiments, the reply is a webpage. In other embodiments, the reply can be JSON data or any other application protocol data. The application and any supporting service(s)/application(s) 105, 105_{S} remain executed and respond to additional incoming requests until there are no more requests. If no additional requests are received for a predetermined period of time, the intent engine 122_{OI} stops the actual application 105, and any supporting service(s)/application(s) 105_{S} and restarts the corresponding proxy application(s) 103.

One or ordinary skill in the art will appreciate that at any given point in time, the present invention provides a service to monitor and respond to incoming service requests.

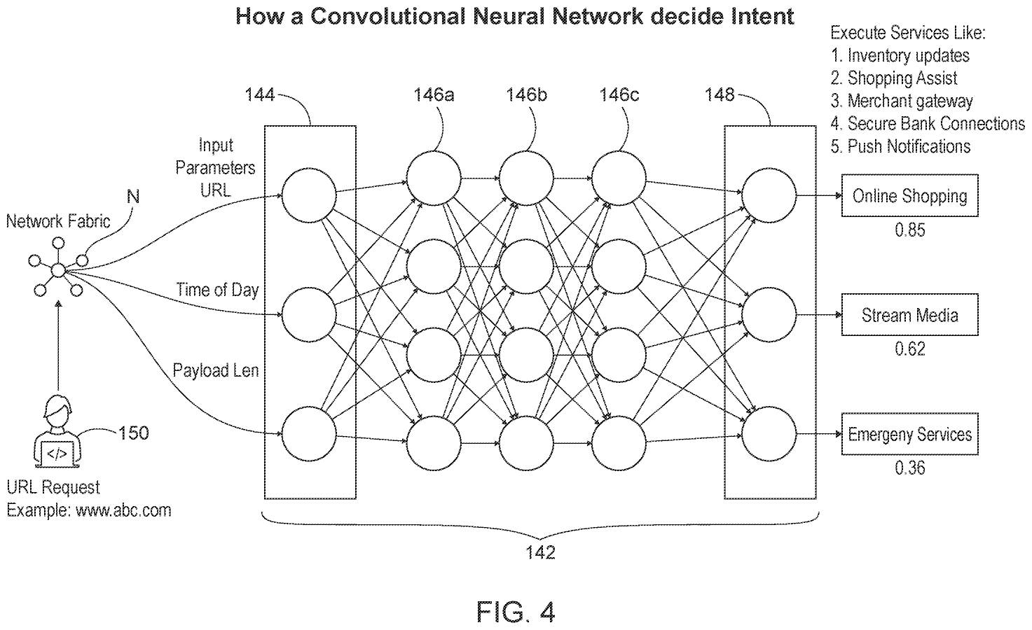

FIG. 4 schematically depicts an exemplary embodiment of the neural network of the intent engine 122_{OI} running on the PaaS layer 122 of the edge server 120 of FIGS. 3A-3D. The convolutional neural network 142 includes an input layer 144, convolutional neural network layers 146a, 146b, 146c, and an output layer 148. In the illustrated embodiment, the input layer 144 of the convolutional neural network 142 receives input parameters such as URL, time of day, payload length from a user 150 and network fabric N, which are contained in the user's service request. The URL received as an input parameter, pre-provisions the services to be predicted by the convolutional neural network 142. The convolutional neural network layers 146a, 146b, 146c, filter the input parameters to create a feature map that summarizes the presence of detected intent features in the input. The detected intent features (i.e., predicted services) are presented at the output layer 148 of the convolutional neural network 142. In one non-limiting exemplary embodiment, the detected intent features presented at the output layer 148 of the neural network 142 can include online shopping service, stream media service, and emergency service. In this embodiment, the PaaS layer 122 of the edge server/master node 120 uses the predicted online shopping service, stream media service, and emergency service to execute applications for these services, such as inventory updates, shopping assist, merchant gateway, secure bank connection, push notifications, and the like. One of ordinary skill in the art will recognize that the detected intent features presented at the output layer 148 of the neural network 142 can include any other relevant services, depending upon the parameters contained in the service request and received at the input layer 144 of the neural network 142.

The convolutional neural network 142 of the intent engine 122_{OI} of the PaaS layer 122 is trained with certain parameters that enable it to identify the intent of the user 150. The parameters used to train the convolutional neural network 142 can include, without limitation, application parameters, network related parameters, firewall related parameters, environment related parameters, parameters relating to customers onboarded on the edge server, or any combination thereof.

The application parameters can include, without limitation, ports opened by the application, SSL or other security parameters used, control messages used to establish connections, the application defined in a zone (internal or external), turnaround time by the application to reply to an incoming request, application triggering internal events, or Application Programming Interface (API) triggers, application access patterns (registered users, guests or anonymous), time duration between two consecutive requests from the same source, traffic pattern when the service request is made, last known presence of the user on the application—transactions made browsing trends, or any combination thereof.

The network related parameters can include, without limitation, flags in the IP packet, payload length, padded bits, source localization, or any combination thereof.

The firewall related parameters can include, without limitation, previously known attacks from region Black list IPs and/or blocked/bad requests.

The environment related parameters can include, without limitation, weather updates in the region and/or community events in a given region.

The parameters relating to customers onboarded on the edge server can include, without limitation, E-commerce customers, government sites, media customers, such as OTT players, academia (students, teachers, researchers), environmentalists, socio economic bloggers, edge maintenance systems to be scaled easily, or any combination thereof.

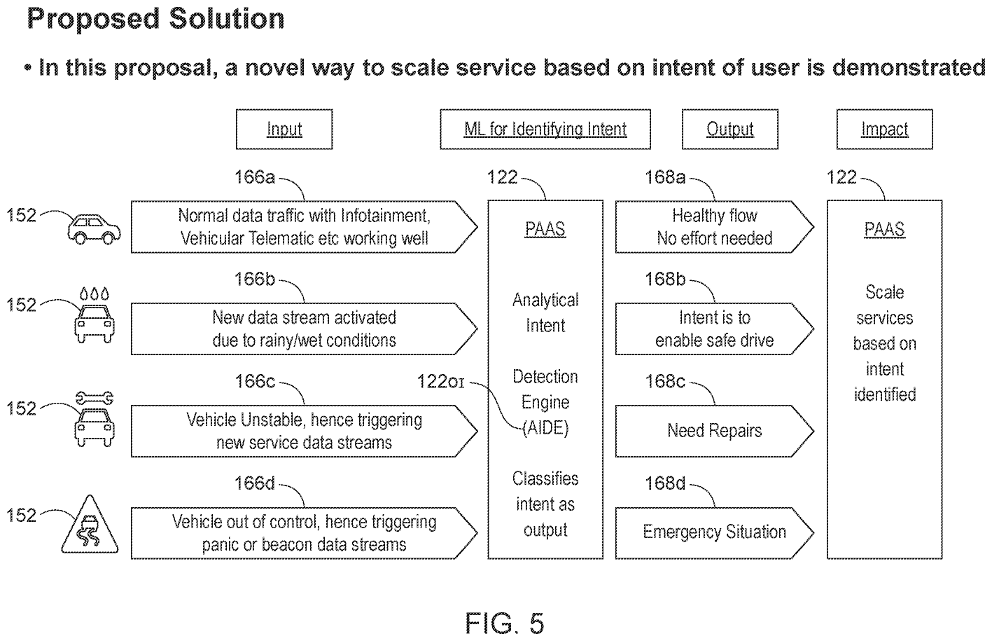

FIG. 5 demonstrates how services can be scaled out by a PaaS layer 122 of the edge server/master node (not shown) based on the detected and classified intents of a user of a motor vehicle 152, where the convolutional neural network 142 of the intent engine 122_{OI} of the orchestrator 122_{O} running on the PaaS layer 122 is trained to detect and classify the intent of the user as normal, special needs, service required, and emergency modes. For example, if in a “vehicular working well” data stream, a user service request contains input parameters 166a that comprise normal data traffic with infotainment and vehicular telematics working normally, an intent of healthy flow is detected by the intent engine 122_{OI} and classified as “no effort needed” at the output 168a of the convolutional neural network 142 of the intent engine 122_{OI}. Therefore, the PaaS layer 122 would not scale out and execute any applications for services. If in a “special needs” data stream, the user service request contains input parameters 166b activated by rainy/wet weather conditions, an intent to enable safe driving services would be detected and classified at the output 168b of the convolutional neural network 142 of the intent engine 122_{OI}. Therefore, the PaaS layer 122 would scale out and execute the appropriate applications to provide services like weather forecasts, nearby hotels, etc. If in a “needs service” data stream, the user service request contains input parameters 166c activated by vehicle instability, an intent to obtain vehicle repair services would be detected and classified at the output 168c of the convolutional neural network 142 of the intent engine 122_{OI}. Therefore, the PaaS layer 122 would scale out and execute the appropriate applications to provide services like brake repair, tire repair, rental cars, etc. If in a “panic or beacon” data stream, the user service request contains input parameters 166d activated by the vehicle being out of control, an intent relating to an emergency situation services would be detected and classified at the output 168d of the convolutional neural network 142 of the intent engine 122_{IO}. Therefore, the PaaS layer 122 would scale out and execute the appropriate applications to provide services such as ambulance and police.

It should be understood that the invention is not limited to the embodiments illustrated and described herein. Rather, the appended claims should be construed broadly to include other variants and embodiments of the invention, which may be made by those skilled in the art without departing from the scope and range of equivalents of the invention. It is indeed intended that the scope of the invention should be determined by proper interpretation and construction of the appended claims and their legal equivalents, as understood by those of skill in the art relying upon the disclosure in this specification and the attached drawings.

1. A method for scaling services at a Platform as a Service (PaaS) layer of a server, comprising:
at the PaaS layer of the server:
executing an application as an application proxy;
exposing the application proxy to a network;
receiving a service request from a user of the network who accessed the application proxy;
detecting an intent of the user;
predicting services that are appropriate in response to the service request of the user based on the detected intent of the user;
scaling the predicted services; and
scheduling the application and any other supporting applications corresponding to the scaled predicted services for execution.

2. The method of claim 1, wherein the executing of the application as the application proxy and the exposing of the application proxy to the network is performed by an orchestrator running on the PaaS layer of the server.

3. The method of claim 1, wherein the application proxy executes on a fraction of a virtual computer processing unit.

4. The method of claim 1, further comprising registering the application to a load balancer using a YAML file prior to executing the application as the application proxy.

5. The method of claim 4, wherein the PaaS layer includes the load balancer.

6. The method of claim 1, wherein the load balancer receives the service request from the user.

7. The method of claim 1, wherein the PaaS layer includes an intent engine for detecting the intent of the user and predicting of the services that are appropriate in response to the service request of the user based on the intent of the user.

8. The method of claim 7, wherein the PaaS layer further includes an orchestrator and wherein the intent engine is a component of the orchestrator.

9. The method of claim 7, wherein the PaaS layer includes a load balancer that executes the intent engine.

10. The method of claim 7, wherein the intent engine comprises a neural network for detecting the intent of the user and predicting of the services that are appropriate in response to the service request of the user based on the intent of the user.

11. The method of claim 10, wherein the neural network includes an input layer, neural network layers, and an output layer, wherein the input layer receives input parameters contained in the service request, wherein the neural network layers filter the input parameters to create a feature map that summarizes the presence of detected intent features in the input, and wherein the detected intent features are presented at the output layer as predicted services.

12. The method of claim 1, wherein the PaaS layer includes a delivery controller for scheduling the executing of the application and any other supporting applications corresponding to the scaled predicted services is scheduled on an associated second server or on an associated computing device.

13. The method of claim 1, wherein the server comprises an edge server of a cloud service provider.

14. A system for scaling services based on identified intent, comprising:
a server including a processor and a memory accessible by the processor;
a set of processor readable instructions stored in the memory that are executable by the processor of the server to:
at a PaaS layer of the server:
execute an application as an application proxy;
expose the application proxy to a network;
receive a service request from a user of the network who accessed the application proxy;
detect an intent of the user;
predict services that are appropriate in response to the service request of the user based on the detected intent of the user;
scale the predicted services; and
schedule the application and any other supporting applications corresponding to the scaled predicted services for execution.

15. The system of claim 14, wherein the executing of the application as the application proxy and the exposing of the application proxy to the network is performed by an orchestrator on the PaaS layer of the server.

16. The system of claim 14, wherein the application proxy executes on a fraction of a virtual computer processing unit.

17. The system of claim 14, further comprising another set of processor readable instructions stored in the memory that are executable by the processor of the server to register the application to a load balancer using a YAML file prior to executing the application as the application proxy.

18. The system of claim 17, wherein the PaaS layer includes the load balancer.

19. The system of claim 14, wherein the load balancer receives the service request from the user.

20. The system of claim 14, further comprising another set of processor readable instructions stored in the memory that are executable by the processor of the server to detect on the PaaS layer the intent of the user and predict the services that are appropriate in response to the service request of the user based on the intent of the user.

21. The system of claim 20, wherein the intent of the user and the predicted services that are appropriate in response to the service request of the user based on the intent of the user are performed by a neural network.

22. The system of claim 21, wherein the neural network includes an input layer, neural network layers, and an output layer, wherein the input layer receives input parameters contained in the service request, wherein the neural network layers filter the input parameters to create a feature map that summarizes the presence of detected intent features in the input, and wherein the detected intent features are presented at the output layer as predicted services.
